(19) United States
(12) Patent Application Publication
(10) Pub. No.: US 2005/0281247 A1
(43) Pub. Date: Dec. 22, 2005

(54) Method and system for acquiring time sync between access points in a broadband wireless access communication system

(75) Inventors: Geun-Hwi Lim, Seongnam-si (KR); Hong-Sung Chang, Suwon-si (KR); Yong Chang, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/157,497

(22) Filed: Jun. 21, 2005

(30) Foreign Application Priority Data
Jun. 21, 2004 (KR) 46310/2004

(51) Int. Cl. H04J 3/06

(52) U.S. Cl. 370/350

(57) ABSTRACT

A method and system for time synchronization between APs in a BWA communication system. According to the method, a second access point acquires a time sync in a broadband wireless access system including a first access point and the second access point. The first access point has already acquired a time sync and the second access point has not acquired the time sync. The method includes the steps of requesting time sync information from the first access point, receiving the time sync information from the first access point, and acquiring the time sync in accordance with the time sync information.

### PRIORITY

This application claims priority to an application entitled “Method And System For Acquiring Time Sync Between Access Points In A Broadband Wireless Access Communication System” filed in the Korean Industrial Property Office on Jun. 21, 2004 and assigned Serial No. 2004-46310, the contents of which are hereby incorporated by reference.

### BACKGROUND OF THE INVENTION

1. Field of the Invention

The present invention relates generally to a method and system for time synchronization in a Broadband Wireless Access (BWA) system, and more particularly to a method and system for time synchronization between Access points (APs) in a BWA system.

2. Description of the Related Art

Currently, the need for a communication system that efficiently provides Internet service is increasing due to users' increasing demand for the Internet service together with the development in the communication industry. However, the existing communication network has been developed mainly to provide voice services and thus has a relatively narrow bandwidth for data transmission and requires a relatively expensive service charge.

In this regard, Institute of Electrical and Electronics Engineers (IEEE) 802.16 standardization group, which is an international standardization organization, is now establishing an IEEE 802.16d standard for providing a broadband wireless Internet service to a stationary subscriber station.

More specifically, a BWA system according to the IEEE 802.16d standard has a wider bandwidth for data transmission and as such, can transmit a much larger quantity of data in short time, in comparison with the conventional wireless technology for voice service. Further, in the BWA system according to the IEEE 802.16d standard, all users can share a channel, thereby achieving efficient use of the channel.

In the BWA system, all users connected to the AP share a common channel, so the AP allocates intervals of the common channel for use of each user at every uplink and downlink frame. Accordingly, the AP must inform uplink and downlink access information to the users every frame in order to enable the users to share the channel.

In the BWA system, access information includes uplink access information and downlink access information, and a MAP message containing the uplink access information or downlink access information is inserted to a front portion of each frame transmitted to the users. The MAP message includes various types of MAP information elements.

The efficient use of the frequency band in the AP is based on the frequency reuse rate. Therefore, in order to increase the efficiency of using the frequency band and facilitate the construction of the AP, it is necessary to make the frequency reuse ratio approach ‘1’. For the frequency reuse ratio to approach ‘1’, it is necessary to achieve exact time synchronization between the APs.

Usually, a separate apparatus for time synchronization between all APs is used in order to achieve exact time synchronization between the APs. For example, each AP may be equipped with a Global Positioning System (GPS) receiver for receiving a GPS signal to achieve the time synchronization between the APs.

Accordingly, the exact time synchronization between the APs is necessary in the conventional BWA system. However, the conventional BWA system has no detailed disclosed method for achieving the time synchronization. As indicated above, a GPS receiver is installed at the AP and synchronizes time by receiving the GPS signal transmitted from a satellite.

Unfortunately, this method using the GPS signal requires that every GPS be equipped with a GPS receiver, which is expensive and inevitably requires an outdoor antenna in order to receive the GPS signal from a satellite.

For a large sized AP installed outdoors, the price of the GPS receiver or the outdoor antenna may cause no problem because the price of the GPS receiver is relatively small in comparison with the large outdoor AP. However, for an AP installed indoors, the price of the GPS receiver may put a considerable burden on the expense for building the AP and a separate outdoor antenna, which is also relatively expensive, is inevitable in order to receive the GPS signal.

### SUMMARY OF THE INVENTION

Accordingly, the present invention has been designed to solve the above and other problems occurring in the prior art. An object of the present invention is to provide a method and system for time synchronization for an AP without a GPS receiver in a BWA communication system.

It is another object of the present invention to provide a method and system for time synchronization for an AP by using a time sync signal provided from another AP.

It is another object of the present invention to provide a method and system for transferring a time sync signal from an AP already having acquired time sync by a GPS signal to another AP without a GPS receiver.

It is another object of the present invention to provide a method and system for transferring a time sync signal from an AP having a GPS receiver to another AP not having a GPS receiver.

It is another object of the present invention to provide a method and system for time synchronization by using a time sync signal provided from an AP already having acquired a sync by a GPS signal.

It is another object of the present invention to provide a method and system for time synchronization between APs by using a time sync signal provided from an AP including a GPS receiver.

It is another object of the present invention to provide a method and system for continuously updating a time sync by using a time sync signal periodically provided from an AP already having acquired a time sync by a GPS signal.

It is another object of the present invention to provide a method and system for continuously updating a time sync by using a time sync signal periodically provided from an AP having a GPS receiver.

It is another object of the present invention to provide a method and system for time synchronization in an AP during which connection of an mobile station (MS) to the AP is temporarily suspended.

It is another object of the present invention to provide a method and system for time synchronization for an AP, where the AP reports the interval for the time synchronization to an MS in advance.

It is another object of the present invention to provide a method and system in which an AP periodically broadcasts a temporary stop control information for temporarily interrupting connection of an MS to the AP.

It is another object of the present invention to provide a method and system in which an MS temporarily interrupts connection to the AP based on a time point for the start of the time sync acquisition and a time sync acquisition period.

In order to accomplish the above and other objects, there is provided a method for acquiring a time sync by a second access point in a broadband wireless access system including a first access point and the second access point, in which the first access point has already acquired a time sync and the second access point has not acquired the time sync. The method comprises the steps of: requesting time sync information from the first access point; receiving the time sync information from the first access point; and acquiring the time sync in accordance with the time sync information.

In accordance with another aspect of the present invention, there is provided a method for supporting time sync acquisition of a second access point by a first access point in a broadband wireless access system including the first access point and the second access point, in which the first access point has already acquired a time sync and the second access point has not acquired the time sync. The method comprises the steps of: receiving a time sync information request message from the second access point; and transmitting the time sync information from the first access point to second access point, such that the second access point can acquire the time sync with the first access point using the time sync information.

In accordance with another aspect of the present invention, there is provided a method for acquiring a time sync with a second access point by a mobile station in a broadband wireless access system including a first access point, the second access point, and the mobile station, in which the first access point has already acquired the time sync, the second access point has not acquired the time sync, and the mobile station is connected with the second access point. The method comprises the steps of: receiving control information from the second access point, which has detected it is necessary to request time sync information from the first access point; interrupting a connection with the second access point in accordance with the control information, and transmitting a time sync information request message to the second access point, after the second access point has acquired the time sync using the time sync information received from the first access point; receiving the time sync information from the second access point; and acquiring the time sync in accordance with the received time sync information.

In accordance with another aspect of the present invention, there is provided a system for acquiring a time sync in a broadband wireless access system. The system comprises a first access point that has already acquired a time sync; a second access point that has not acquired the time sync; and a mobile station connected with the second access point, wherein the mobile station receives control information from the second access point, which has detected it is necessary to request time sync information from the first access point, interrupts connection with the second access point in accordance with the control information, transmits a time sync information request message to the second access point, after the second access point has acquired the time sync by receiving the time sync information from the first access point, receives the time sync information from the second access point, and acquires the time sync in accordance with the received time sync information.

In accordance with another aspect of the present invention, there is provided a system for supporting time sync acquisition in a broadband wireless access system. The system comprises a first access point that has already acquired a time sync; and a second access point that has not acquired the time sync, wherein the first access point receives a time sync information request message from the second access point, and transmits the time sync information from the first access point to second access point, such that the second access point can acquire the time sync with the first access point using the time sync information.

In accordance with another aspect of the present invention, there is provided a system for acquiring a time sync in a broadband wireless access system. The system comprises a first access point that has already acquired a time sync; and a second access point that has not acquired the time sync, wherein the second access point requests time sync information from the first access point, receives the time sync information from the first access point, and acquires a time sync in accordance with the time sync information.

### BRIEF DESCRIPTION OF THE DRAWINGS

The above and other objects, features, and advantages of the present invention will become more apparent from the following detailed description when taken in conjunction with the accompanying drawings, in which:

FIG. 1 is a block diagram schematically illustrating a BWA system according to an embodiment of the present invention, in which an AP having a GPS receiver provides the time sync information;

FIG. 2 is a flow diagram illustrating a signaling process for initial time synchronization between APs in a BWA system according to an embodiment of the present invention;

FIG. 3 is a flow diagram illustrating a signaling process for periodically updating the time sync between the APs in a BWA system;

FIGS. 4A through 4C illustrates a flowchart of a control process by a micro AP for acquiring time sync according to an embodiment of the present invention;

FIG. 5 is a flowchart illustrating a control process performed by the macro AP for time synchronization; and

FIG. 6 is a flowchart illustrating a control process performed by the MS for time synchronization.

### DETAILED DESCRIPTION OF THE PREFERRED EMBODIMENT

Hereinafter, preferred embodiments of the present invention will be described in detail with reference to the accompanying drawings. In the following description, a detailed description of known functions and configurations incorporated herein will be omitted when it may obscure the subject matter of the present invention.

The present invention proposes a system and method for acquiring a time sync between APs by using time sync information collected from one of the APs. Herein, the AP providing the time sync information is an AP already having acquired the time sync, which may be, for example, an AP having a GPS receiver or already having acquired the time sync without a GPS receiver. Additionally, in the following description, the macro AP represents an AP having a GPS receiver and the micro AP represents an AP that must receive and acquire the time sync from another AP already having acquired the time sync.

In order to implement the embodiments of the present invention, it is necessary to define the format and generation of MAP information elements necessary for time synchronization and functions of parameters included in the MAP information elements. Further, a signaling process between an AP providing the time sync information and another AP necessary to acquire the time sync information will be disclosed. Additionally, a process for updating the periodically provided time sync information, after the initial time synchronization between APs, will be described.

1. Structure of a BWA System

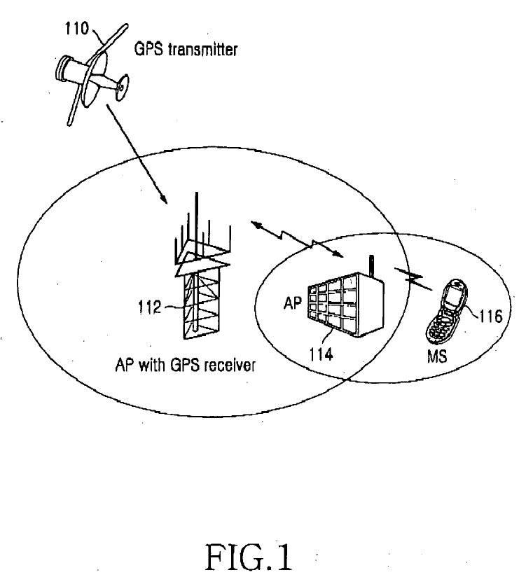

FIG. 1 is a block diagram illustrating a BWA system according to an embodiment of the present invention, in which an AP having a GPS receiver provides the time sync information. However, the time sync information may also be provided from an AP having no GPS receiver, but that has already acquired the time sync from another AP connected to the AP. Therefore, the scope of the present invention includes a construction in which an AP can acquire a time sync from time sync information provided from another AP connected to the AP.

Referring to FIG. 1, a GPS transmitter 110 continuously transmits a GPS signal carrying time sync information. By receiving the GPS signal from the GPS transmitter 110, it is possible to acquire a time sync from the time sync information. The time sync information is information indicating a current time point.

An outdoor AP (or an AP having a GPS receiver) 112 is an AP located outdoors and has a GPS receiver capable of receiving the GPS signal. Therefore, the outdoor AP 112 receives the GPS signal from the GPS transmitter 110 and synchronizes time with the GPS signal by updating a clock used in the outdoor AP 112. That is, the outdoor AP 112 acquires a time sync from the GPS signal. Thereafter, the outdoor AP 112 synchronizes time with an indoor AP 114 based on the acquired time sync. The indoor AP 114 is an AP located indoors and has no GPS receiver. Therefore, the indoor AP 114 synchronizes time with the outdoor AP 112 based on the time sync acquired from the GPS signal. More specifically, the time synchronization by the indoor AP 114 is performed by updating a clock used in the indoor AP 114 so as to synchronize the clock of the indoor AP 114 with the clock of the outdoor AP 112.

Using the process described above, the outdoor AP 112 and the indoor AP 114 are synchronized with the GPS time.

As time passes, a difference may occur between the clock of the indoor AP 114 and the clock of the outdoor AP 112. Therefore, in order to periodically update the clock, the indoor AP 114 may determine a period (hereinafter, referred to as a “time sync acquisition period”) and performs a process for the time synchronization at the time sync acquisition period, thereby periodically updating the clock.

While the indoor AP 114 performs the process for the time synchronization, it is necessary to interrupt the connection between the MS 116 and the indoor AP 114. That is, the indoor AP 114 broadcasts temporary stop control information. It is necessary to broadcast the temporary stop control information at least once within the time sync acquisition period. Of course, when the temporary stop control information is broadcasted multiple times within the time sync acquisition period, the temporary stop control information may have a different value (content) whenever it is broadcasted.

The MS 116 connects the indoor AP 114 to benefit from a desired communication from the indoor AP 114. Also, the MS 116 receives the temporary stop control information broadcasted from the indoor AP 114 and interrupts the connection with the indoor AP 114 at an interval indicated by the temporary stop control information. The temporary stop control information includes a start frame offset and a frame duration. The start frame offset indicates the time point at which the indoor AP 114 must start the process for the time synchronization.

The outdoor AP 112 broadcasts a preamble signal at a predetermined interval, e.g., 5 ms, based on the acquired time sync, in order to acquire an initial sync with the indoor AP 114 adjacent to the outdoor AP 112 or an MS (not shown) connectable to the outdoor AP 112. The indoor AP 114 or the connectable MS sends a ranging request to the outdoor AP 112 in accordance with the initial sync acquired through the preamble signal. The outdoor AP 112 receives the ranging request from the indoor AP 114 acquired the initial sync through the preamble signal. Thereafter, based on the time point at which the ranging request is received, the outdoor AP 112 determines a transmission delay value for the indoor AP 114 or the connectable MS.

More specifically, because the outdoor AP 112 and the indoor AP 114 have the same initial sync acquired from the preamble signal, the outdoor AP 112 can predict a time at which it will receive the ranging request from the indoor AP 114 or the connectable MS. However, the time point at which the ranging request from the indoor AP 114 or the connectable MS is actually received may differ from the predicted time point, when the transmission delay due to the distance between the outdoor AP 112 and the indoor AP 114 or the connectable MS is not taken into account in the prediction.

Therefore, upon receiving the ranging request, the outdoor AP 112 calculates a round-trip transmission delay value based on the difference between the time point for actual reception of the ranging request and the predicted time point. Thereafter, the outdoor AP 112 calculates the transmission delay value based on the round-trip transmission delay value and transmits the calculated transmission delay value to the indoor AP 114 or the connectable MS.

The indoor AP 114 or the connectable MS updates its own time sync using the transmission delay value provided by the outdoor AP 112.

2. Process for Initial Time Sync

Hereinafter, a process in which an AP without a GPS receiver initially acquires a time sync will be described. More specifically, in the following description, the initial time sync refers to a time sync acquired for the first time between APs, not the initial sync acquired from the preamble signal. The following description is based on an assumption that the initial sync from the preamble signal has been already acquired.

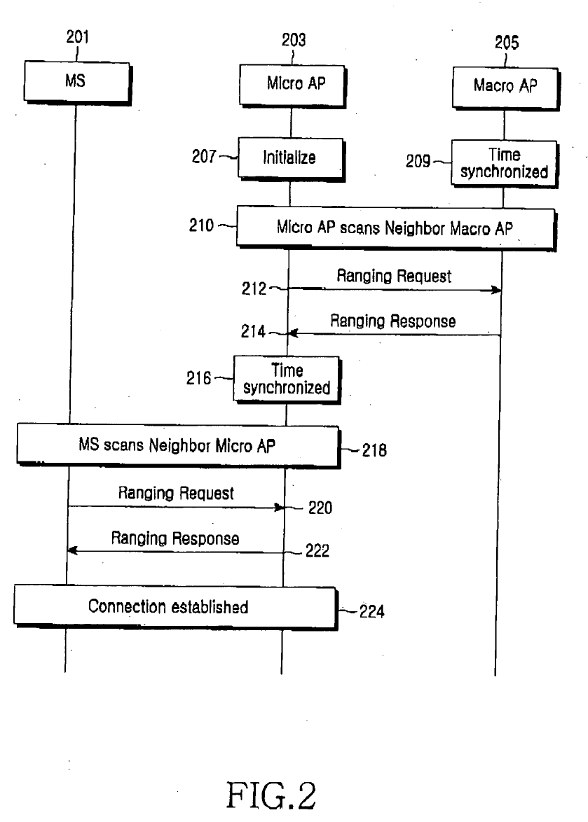

FIG. 2 is a flow diagram illustrating a signaling process for time synchronization between a macro AP 205 and a micro AP 203 according to an embodiment of the present invention. The macro AP 205 is an AP having a GPS receiver, or an AP that has already acquired the time sync, e.g., the outdoor AP 112 in FIG. 1. The micro AP 203 must receive and acquire the time sync, and corresponds to the indoor AP 114 in FIG. 1.

Referring to FIG. 2, it is assumed that the micro AP 203 is in an initial state in step 207 while the macro AP 205 is in an already time-synchronized state in step 209. The micro AP 203 scans a neighbor macro AP 205 in step 210. If multiple neighbor macro APs are scanned, the micro AP 203 selects one of them as the macro AP 205. Various ways of selecting one macro AP from multiple macro APs can be defined. For example, a macro AP scanned first may be selected from the multiple macro APs.

When one macro AP 205 has been found or selected through the scanning, the micro AP 203 connects with the macro AP 205 and transmits a ranging request message requesting time sync information for time synchronization to the macro AP 205 in step 212. The ranging request message may include information from which the macro AP 205 can confirm the current sync state of the micro AP 203. Further, the information provided to the macro AP 205 by the ranging request message may include clock information that the micro AP 203 currently uses.

Upon receiving the ranging request message, the macro AP 205 determines the degree for which the clock of the micro AP 203 must be updated. In order to determine the degree (e.g., time sync information or transmission delay value) for the update of the clock, the macro AP 205 refers to the time point at which the ranging request message is received. That is, the macro AP 205 calculates the update information (time sync information or transmission delay value) using the difference between the time point at which the ranging request is actually received and the predicted time point. The macro AP 205 transmits a ranging response message including the time sync information (or transmission delay value) to the micro AP 203 in step 214.

The micro AP 203 receives the ranging response message and confirms the time sync information carried by the ranging response message. From the time sync information, the micro AP 203 can understand the frame number of the macro AP 205 and the exact sync interval of each frame. Thereafter, the micro AP 203 interrupts the connection with the macro AP 205 and updates the current clock based on the time sync information in step 216. As a result of the time synchronization between the clock used in the micro AP 203 and the clock used in the macro AP 205, the micro AP 203 and the macro AP 205 have the same time sync.

Thereafter, the MS 201 scans neighbor micro AP 203 in step 218. When multiple neighbor micro APs are scanned, the MS 201 selects a micro AP from the multiple neighbor micro APs. As described above, various ways of selecting one micro AP from multiple micro APs can be defined. For example, a micro AP located most adjacently to the MS may be selected from the multiple micro APs.

When one micro AP 203 has been found or selected through the scanning, the MS 201 transmits a ranging request message requesting time sync information for time synchronization to the micro AP 203 in step 220.

Upon receiving the ranging request message from the MS 201, the micro AP 203 determines the time sync information for synchronization with the MS 201 based on the difference between the time point of actual reception of the ranging request message and the predicted time point. In step 222, the micro AP 203 transmits a ranging response message including the time sync information to the MS 201.

The MS 201 receives the ranging response message and acquires the time sync with the micro AP 203 from the time sync information included in the ranging response message. In step 224, the MS 201 establishes the connection between the MS 201 and the micro AP 203, such that the MS 201 can benefit from the communication service provided from the micro AP 203.

The macro AP 205 may insert a macro AP identifier bit for identifying the macro AP 205, in addition to the time sync information, in the ranging response message transferred to the micro AP 203. The macro AP identifier bit is used to determine if the macro AP 205 has a GPS receiver. For example, if the macro AP 205 has a GPS receiver, the macro AP 205 transmits a macro AP identifier bit of “0” by the ranging response message. However, if the macro AP 205 does not have a GPS receiver, the macro AP 205 transmits a macro AP identifier bit of “1” by the ranging response message. Further, the macro AP identifier bit can be used to indicate the ordinal number of an AP from among APs connected to the macro AP having the GPS receiver.

By using the identifier bit for identifying the macro AP 205, the micro AP 203 can recognize the reliability of the time sync information provided from the macro AP 205.

3. Process for Periodic update of Time Sync

Hereinafter, a process of periodically updating the time sync in an AP having no GPS according to an embodiment of the present invention will be described.

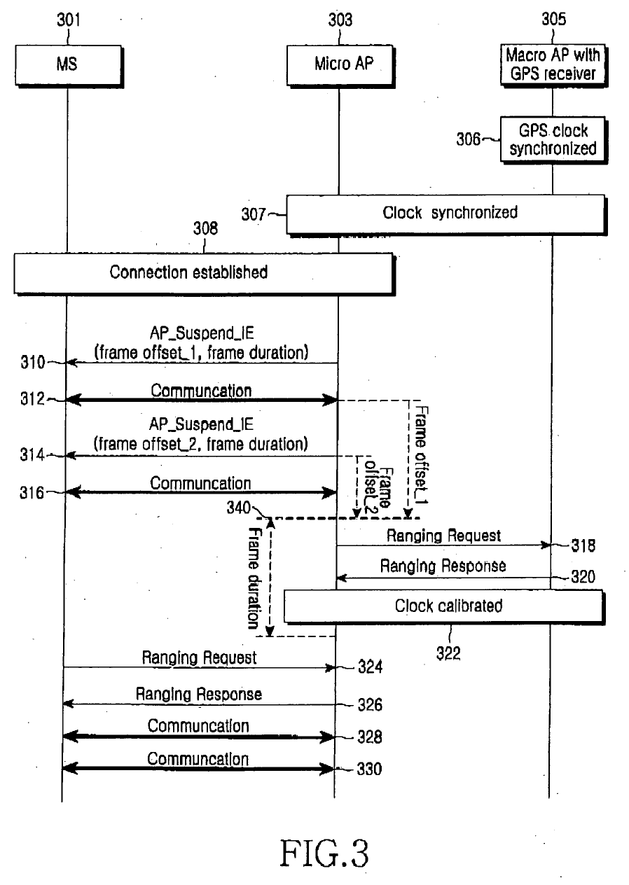

FIG. 3 is a flow diagram of a signaling process between a macro AP 305 and a micro AP 303 for periodically updating the time sync between the APs in a state in which the initial time sync has been already acquired. The macro AP 305 has a GPS receiver or has already acquired the time sync, and corresponds to the outdoor AP 112 illustrated in FIG. 1. The micro AP 303 has received the time sync information and acquired the initial time sync, and corresponds to the indoor AP 114 illustrated in FIG. 1.

FIG. 3 is based on an assumption that the macro AP 305 has been already synchronized with the GPS clock in step 306 and the initial time has been already synchronized between the macro AP 305 and the micro AP 303 in step 307. Also, it is presumed that the connection has been already established between the MS 301 and the micro AP 303 through acquisition of the initial time sync so that the micro AP 303 has provided a communication service to the MS 301 in step 308.

In step 310, the micro AP 303 broadcasts an AP_Suspend_IE message including the temporary stop control information to the MS 301. The temporary stop control information includes information about a time point (Frame offset_1) at which the micro AP 303 starts the periodic time synchronization and an interval (Frame duration) during which the micro AP 303 performs the periodic time synchronization. The present invention proposes MAP information elements for transmitting the temporary stop control information as shown in Table 1 below.

TABLE 1

| Syntax | Size | Notes |
|---|---|---|
| AP_Suspend_IE { | | |

| | |
|---|---|
| Extended DIUC = 8 | 4 bits |
| Length | 4 bits |
| Start frame offset | 8 bits |
| Frame Duration | 8 bits |

}

In Table 1, ‘Start frame offset’ indicates the ordinal number of the frame at which the micro AP 303 stops from the frame at which the AP_Suspend_IE message was sent, and ‘Frame Duration’ indicates the number of frames during which the micro AP 303 stops. Therefore, by receiving the temporary stop control information, the MS 301 can understand the time point at which the micro AP 303 will perform the time synchronization and the duration for which the micro AP 303 will perform the time synchronization.

When the transmission period of the AP_Suspend_IE message arrives while the micro AP 303 provides a communication service to the MS 301 in step 312, the micro AP 303 broadcasts the AP_Suspend_IE message including the temporary stop control information to the MS 301 in step 314. The temporary stop control information includes information about a time point (Frame offset_2) at which the micro AP 303 starts the periodic time synchronization and an interval (Frame duration) during which the micro AP 303 performs the periodic time synchronization. The ‘Frame offset_1’ in step 310 and the ‘Frame offset_2’ in step 314 have different values, because ‘Frame offset_2’ is determined from ‘Frame offset_1’ in consideration of the transmission period for the AP_Suspend_IE message. That is, the ‘Frame Offset_1’ is transmitted in advance, after being determined based on the transmission period of the ‘Frame Offset_2’ and the time point 340 at which the synchronization process for the micro AP 303 is started.

In steps 312 and 316, the communication service between the micro AP 303 and the MS 301, the connection of which has already been established, is provided until the time point 340 arrives, when the process of time synchronization of the micro AP starts. The time point 340 is determined based on the ‘Frame offset_1’ or the ‘Frame offset_2’ provided in advance.

The micro AP 303 broadcasts a plurality of AP_Suspend_IE messages in consideration of MSs in a sleep mode or an idle mode.

When the time point 340 to perform the process of periodic time synchronization comes, the micro AP 303 performs the periodic time synchronization during the ‘Frame Duration’ in steps 318 through 322.

More specifically, steps 318 through 322 in FIG. 3 are the same as steps 212 through 216 in FIG. 2, which were described above. Therefore, a detailed description about steps 318 through 322 will be omitted.

However, the time during which the micro AP 303 connects with the macro AP 305 and then acquires the clock sync must be sufficiently short so as to prevent occurrence of too much error in the clock of the MS 301. When it takes too long time for the clock synchronization or time synchronization, the MS 301 and the micro AP 303 must synchronize their clocks again through the above-described process.

In steps 324 through 328, a process for time synchronization between the MS 301 and the micro AP 303, which has newly acquired a time sync through the periodic time synchronization process, is performed. Steps 324 through 328 in FIG. 3 are the same as steps 220 and 222 in FIG. 2. Using the time sync newly acquired, the communication service continues between the micro AP 303 and the MS 301 in steps 328 and 330.

4. Operation of Micro AP

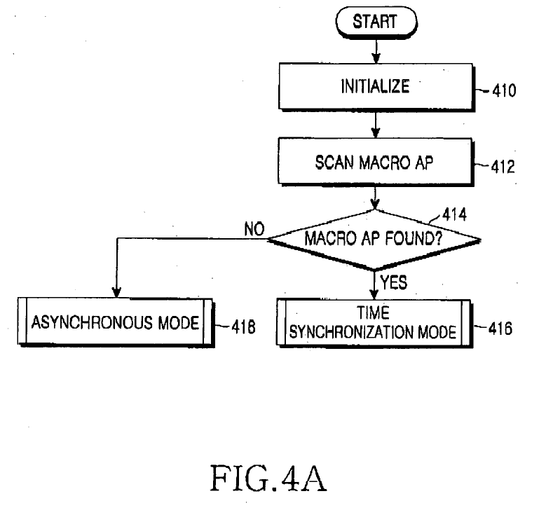

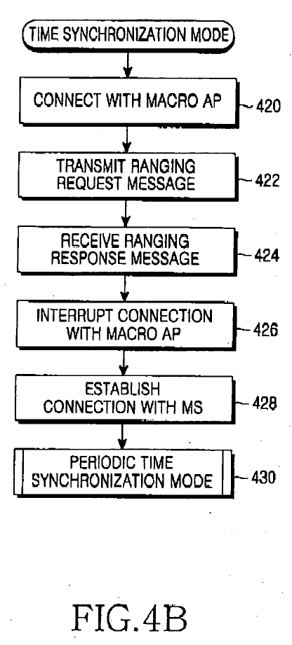

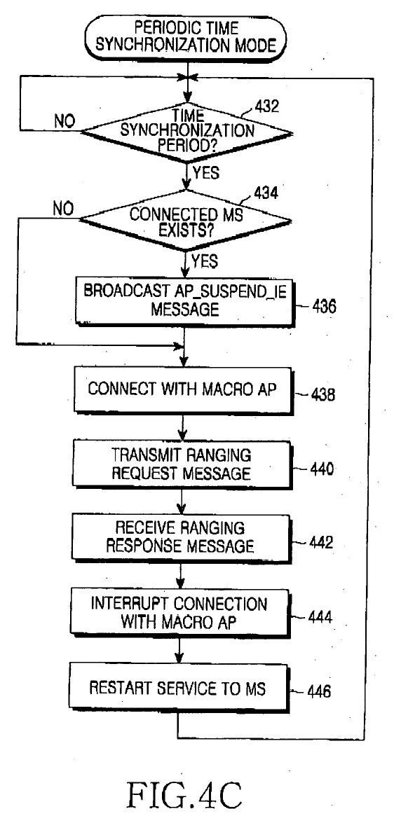

Hereinafter, the operation of the micro AP according to an embodiment of the present invention will be described with reference to FIGS. 4A through 4C. The following description is based on an assumption that the micro AP has already acquired the initial sync from the preamble signal periodically broadcasted from the macro AP.

More specifically, FIGS. 4A through 4C illustrates a flowchart of a control process by a micro AP in order to acquire a time sync according to an embodiment of the present invention. In step 410, the micro AP performs initialization. The process of initialization may include a step of acquiring an initial sync from a preamble signal periodically broadcasted from the macro AP. When the initialization has been completed, the micro AP scans neighbor macro APs in step 412. When a macro AP has been found or selected in step 414, the micro AP performs a process according to a time synchronization mode for acquiring a time sync with the macro AP in step 416. FIG. 4B illustrates the process according to the time synchronization mode in more detail. When the micro AP has failed the scanning, that is, failed to find or select a macro AP, in step 418, the micro AP performs a typical asynchronous mode operation, which has no direct relation to the present invention and will not be described further.

Referring to FIG. 4B, after entering the time synchronization mode, the micro AP connects with the macro AP in step 420. In step 422, the micro AP transmits a ranging request message requesting time sync information to the macro AP. The ranging request message may include information by which the macro AP can confirm the current sync state of the micro AP.

Thereafter, in step 424, the micro AP receives the ranging response message from the macro AP and confirms the time sync information carried by the ranging response message. From the time sync information, the micro AP can understand the frame number of the macro AP and the exact sync interval of each frame.

After confirming the time sync information, the micro AP updates the clock to be used in the micro AP by using the time sync information, such that the clock used in the micro AP is synchronized with the clock used in the macro AP.

The micro AP interrupts the connection with the macro AP in step 426 and establishes the connection with the MS requesting the connection in step 428. Wile simultaneously establishing the connection with the MS, the micro AP performs a process to be synchronized with the MS.

When the initial time synchronization has been completed, the micro AP proceeds to step 430 and enters into the periodic time synchronization mode. In the periodic time synchronization mode, the micro AP performs a process for revising an error occurring in the clock according to passage of time.

FIG. 4C illustrates the operation in the periodic time synchronization more in detail. Referring to FIG. 4C, after entering into the periodic time synchronization mode, the micro AP determines if the time point for performing the time synchronization has arrived in step 432. The time point for performing the time synchronization is determined based on a proper period for maintaining the time sync at an optimum state.

When the time point for performing the time synchronization has arrived, the micro AP determines if an MS is currently connected to the micro AP. When there is no MS currently connected to the micro AP, the micro AP proceeds to step 438. However, when an MS is currently connected to the micro AP, the micro AP proceeds to step 436 in which the micro AP broadcasts the AP_Suspend_IE message including the temporary stop control information to the connected MS. The temporary stop control information is information defining the time point (Frame offset_1) at which the micro AP starts the periodic time synchronization and the interval (Frame duration) during which the micro AP performs the periodic time synchronization. Accordingly, by receiving the temporary stop control information, the MS can understand the time point at which the micro AP will perform the time synchronization and the duration for which the micro AP will perform the time synchronization.

In the process described above, the micro AP broadcasts the AP_Suspend_IE message to the connected MS only when it comes for the micro AP to perform the time synchronization. However, as described above with reference to FIG. 3, the micro AP may periodically broadcast the AP_Suspend_IE message regardless of the time point for the time synchronization.

After broadcasting the AP_Suspend_IE message, the micro AP connects with the macro AP in step 438 and transmits a ranging request message requesting time sync information to the macro AP in step 440. The micro AP receives the ranging response message from the macro AP and confirms the time sync information carried by the ranging response message in step 442. The micro AP interrupts the connection with the macro AP in step 444 and updates the current clock based on the time sync information. That is, the clock used in the micro AP is synchronized with the clock used in the macro AP, such that the time synchronization between the micro AP and the macro AP is established.

Thereafter, the micro AP restarts the supply of service to the connected MS in step 446 and then returns to step 432. Thereafter, the micro AP continuously performs the operation in the periodic time synchronization mode.

If the micro AP has received a macro AP identifier bit through the ranging response message, the micro AP can determine the reliability of the time sync information provided from the macro AP based on the macro AP identifier bit.

5. Operation of Macro AP

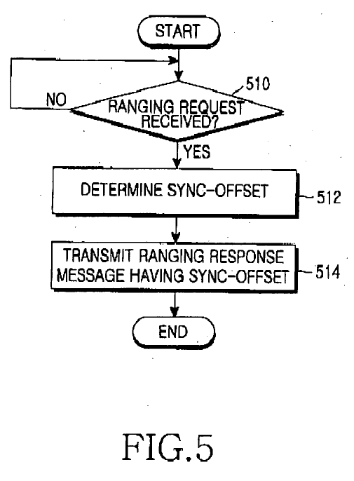

Hereinafter, the operation of the macro AP according to an embodiment of the present invention will be described with reference to FIG. 5, which is a flowchart illustrating the control process performed by the macro AP for the time synchronization.

Referring to FIG. 5, in step 510, the macro AP determines if a ranging request message from the micro AP is received. When a ranging request message from the micro AP is received, the macro AP determines the degree of update for the clock of the micro AP in step 512. In order to determine the degree (Sync-offset) of update for the clock, the macro AP refers to a predicted time point and an actual point for reception of the ranging request message.

After determining the degree of update for the clock, the macro AP inserts the determined degree (Sync_offset) of update for the clock as time sync information into a ranging response message and then the ranging response message to the micro AP in step 514.

The operation of the macro AP can be performed independently from the initial time synchronization process and the periodic time synchronization process.

6. Operation of MS

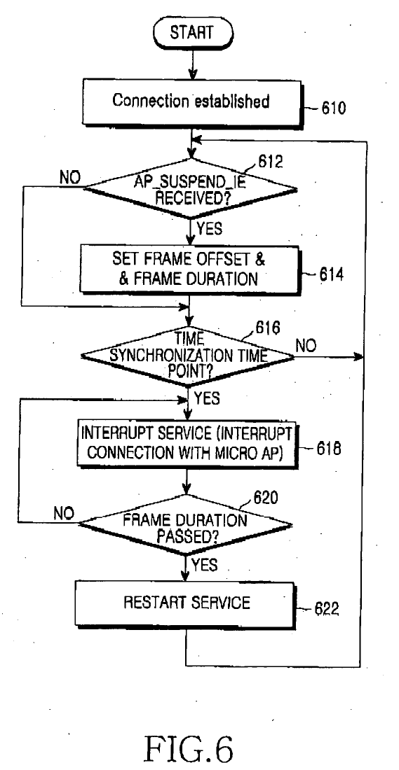

Hereinafter, the operation of the MS according to an embodiment of the present invention will be described with reference to FIG. 6, which is a flowchart illustrating the control process performed by the MS for the time synchronization.

Referring to FIG. 6, in step 610, the MS establishes the connection with the micro AP to which the MS belongs, so that it can benefit from the communication service provided from the micro AP. After the connection with the micro AP is established, the MS determines if the AP_Suspend_IE message broadcasted from the micro AP has been received in step 612. When the MS has not received the AP_Suspend_IE message, the MS proceeds to step 616. The AP_Suspend_IE message carries the temporary stop control information to the MS. The temporary stop control information includes information about the time point (Frame Offset) at which the micro AP starts the periodic time synchronization and the interval (Frame duration) during which the micro AP performs the periodic time synchronization.

After receiving the AP_Suspend_IE message, the MS sets the ‘Frame Offset’ and the ‘Frame Duration’ confirmed from the AP_Suspend_IE message in step 614. By confirming the ‘Frame Offset’ and the ‘Frame Duration’, the MS can understand the time point at which the micro AP will start the time synchronization and the duration for which the micro AP will perform the time synchronization.

After confirming if the micro AP will perform the time synchronization, the MS monitors if the time point for the time synchronization by the micro AP arrives in step 616. The time point for the time synchronization by the micro AP is determined by the ‘Frame Offset’. If it is determined that the time point for the time synchronization by the micro AP has arrived, the MS proceeds to step 618, where the MS interrupts the communication service from the micro AP, that is, interrupts the connection with the micro AP. However, if it is determined that the time point for the time synchronization by the micro AP has not come yet, the MS returns to step 612.

After the interruption of the communication service in step 618, the MS monitors if the ‘Frame Duration’ for the time synchronization by the micro AP has passed in step 620. If it is determined that the ‘Frame Duration’ for the time synchronization by the micro AP has passed, the MS connects with the micro AP and restarts the communication service in step 622. However, if it is determined that the ‘Frame Duration’ for the time synchronization by the micro AP has not passed yet, the MS returns to step 618. When the communication service from the micro AP has restarted, the MS returns to step 612 and then repeats the above-described process.

As described above, the present invention proposes a method for initial time synchronization of an AP that does not have a GPS receiver by using time sync information provided from a neighbor AP having a GPS receiver or that has already acquired the time sync even without the GPS receiver. Also, the present invention provides a periodic time synchronization process that can prevent a difference between clocks in APs.

According to the present invention, the AP without a GPS receiver periodically requests the time sync information and the AP having a GPS receiver provides the time sync information in response to the request. Additionally, the AP without a GPS receiver preliminarily reports the period for the time synchronization to the MSs to which the AP provides the communication service, thereby preventing the MSs from unnecessarily accessing the AP.

As described above, the present invention proposes a process in which an AP without a GPS receiver acquires a time sync by the help of another AP having a GPS receiver or that has already acquired the time sync. By using the technology according to the present invention, it is possible to develop a synchronous AP that may even have a difficulty in receiving the GPS signal because, for example, it is installed indoors. Further, the omission of the GPS receiver can reduce the cost for building an AP.

Further, according to the present invention, it is possible to prevent unnecessary connection of an MS with the AP, which may occur in the course of the time synchronization by the AP, and thus, it is possible to reduce power consumption of the MS.

While the present invention has been shown and described with reference to certain preferred embodiments thereof, it will be understood by those skilled in the art that various changes in form and details may be made therein without departing from the spirit and scope of the present invention as defined by the appended claims.

1. A method for acquiring a time sync by a second access point in a broadband wireless access system including a first access point and the second access point, in which the first access point has already acquired a time sync and the second access point has not acquired the time sync, the method comprising the steps of:
requesting time sync information from the first access point;
receiving the time sync information from the first access point; and
acquiring the time sync in accordance with the time sync information.

2. The method as claimed in claim 1, wherein the step of requesting the time sync information comprises requesting the time sync information from the first access point together with transmitting time sync information of the second access point to the first access point.

3. The method as claimed in claim 2, wherein the time sync information received from the first access point includes an offset between time sync information of the second access point and the time sync information of the first access point.

4. The method as claimed in claim 3, wherein the step of acquiring the time sync comprises adjusting the time sync information of the second access point in accordance with the offset.

5. The method as claimed in claim 1, wherein the step of requesting the time sync information is performed at a predetermined period.

6. The method as claimed in claim 1, further comprising the steps of:
receiving a request for the time sync information from a mobile station that has not acquired the time sync;
transmitting the time sync information to the mobile station in response to the request; and
connecting with the mobile station, after the mobile station acquires the time sync using the received time sync information.

7. The method as claimed in claim 6, further comprising the steps of:
transmitting control information to the mobile station that has connected with the second access point, after acquiring the time sync, when it is necessary to request the time sync information from the first access point;
interrupting the connection with the mobile station;
requesting the time sync information from the first access point;
receiving the time sync information from the first access point;
acquiring the time sync corresponding to the received time sync information; and
restarting the connection with the mobile station.

8. The method as claimed in claim 7, wherein the control information includes information about a time point at which the time sync information is requested and a duration necessary for acquiring the time sync.

9. The method as claimed in claim 8, wherein the step of interrupting the connection with the mobile station continues from the time point at which the time sync information is requested until the time sync is acquired.

10. The method as claimed in claim 8, wherein the connection with the mobile station is restarted from the time point when the time sync information is acquired.

11. A method for supporting time sync acquisition of a second access point by a first access point in a broadband wireless access system including the first access point and the second access point, in which the first access point has already acquired a time sync and the second access point has not acquired the time sync, the method comprising the steps of:
receiving a time sync information request message from the second access point; and
transmitting the time sync information from the first access point to second access point, such that the second access point can acquire the time sync with the first access point using the time sync information.

12. The method as claimed in claim 11, wherein the step of receiving the time sync information request message comprises receiving time sync information of the second access point included in the time sync information request message.

13. The method as claimed in claim 12, wherein the time sync information transmitted from the first access point to the second access point includes an offset between time sync information of the second access point and the time sync information of the first access point.

14. The method as claimed in claim 11, wherein the time sync information request message is received at a predetermined period.

15. The method as claimed in claim 11, wherein the time sync information includes identification information of the first access point and the time sync information to the second access point.

16. A method for acquiring a time sync with a second access point by a mobile station in a broadband wireless access system including a first access point, the second access point, and the mobile station, in which the first access point has already acquired the time sync, the second access point has not acquired the time sync, and the mobile station is connected with the second access point, the method comprising the steps of:
receiving control information from the second access point, which has detected it is necessary to request time sync information from the first access point;
interrupting a connection with the second access point in accordance with the control information, and transmitting a time sync information request message to the second access point, after the second access point has acquired the time sync using the time sync information received from the first access point;
receiving the time sync information from the second access point; and
acquiring the time sync in accordance with the received time sync information.

17. The method as claimed in claim 16, wherein the step of transmitting the time sync information request message to the second access point comprises transmitting time sync information of the mobile station together with the time sync information request message to the second access point.

18. The method as claimed in claim 17, wherein the time sync information of the mobile station includes information about a clock in the mobile station.

19. The method as claimed in claim 17, wherein the time sync information received from the second access point includes an offset between the time sync information of the second access point and the time sync information of the mobile station.

20. The method as claimed in claim 19, wherein the step of acquiring the time sync in accordance with the received time sync information from the second access point comprises adjusting the time sync information of the mobile station in accordance with the offset.

21. The method as claimed in claim 16, wherein the step of requesting the time sync information is performed at a predetermined period.

22. A system for acquiring a time sync in a broadband wireless access system, the system comprising:
a first access point that has already acquired a time sync; and
a second access point that has not acquired the time sync,
wherein the second access point requests time sync information from the first access point, receives the time sync information from the first access point, and acquires a time sync in accordance with the time sync information.

23. The system as claimed in claim 22, wherein the second access point requests the time sync information from the first access point together with transmitting time sync information of the second access point.

24. The system as claimed in claim 23, wherein the time sync information from the first access point includes an offset between time sync information of the second access point and the time sync information of the first access point.

25. The system as claimed in claim 24, wherein the second access point acquires the time sync by adjusting the time sync information of the second access point in accordance with the offset.

26. The system as claimed in claim 22, wherein the second access point requests the time sync information at a predetermined period.

27. The system as claimed in claim 22, wherein the second access point receives a request for the time sync information from a mobile station that has not acquired the time sync, transmits the time sync information to the mobile station in response to the request, and connects with the mobile station, after the mobile station acquires the time sync using the received time sync information.

28. The system as claimed in claim 27, wherein the second access point transmits control information to the mobile station that has connected with the second access point, after acquiring the time sync, when it is necessary to request the time sync information to the first access point, interrupts the connection with the mobile station having received the control information and requesting the time sync information to the first access point, receives the time sync information from the first access point as a response to the request, and restarts the connection with the mobile station, after acquiring the time sync corresponding to the received time sync information.

29. The system as claimed in claim 28, wherein the control information includes information about a time point at which the time sync information is requested and a duration necessary for acquiring the time sync.

30. The system as claimed in claim 29, wherein the second access point interrupts the connection with the mobile station from the time point at which the time sync information is requested until the time sync is acquired.

31. The system as claimed in claim 29, wherein the second access point restarts the connection with the mobile station from the time point when the time sync information is acquired.

32. A system for supporting time sync acquisition in a broadband wireless access system, the system comprising:
a first access point that has already acquired a time sync; and
a second access point that has not acquired the time sync,
wherein the first access point receives a time sync information request message from the second access point, and transmits the time sync information from the first access point to second access point, such that the second access point can acquire the time sync with the first access point using the time sync information.

33. The system as claimed in claim 32, wherein the first access point receives time sync information of the second access point included in the time sync information request message.

34. The system as claimed in claim 33, wherein the time sync information transmitted from the first access point to the second access point includes an offset between time sync information of the second access point and the time sync information of the first access point.

35. The system as claimed in claim 32, wherein the first access point receives the time sync information request message at a predetermined period.

36. The system as claimed in claim 32, wherein the first access point transmits identification information of the first access point together with the time sync information to the second access point.

37. A system for acquiring a time sync in a broadband wireless access system, the system comprising:
a first access point that has already acquired a time sync;
a second access point that has not acquired the time sync; and
a mobile station connected with the second access point,
wherein the mobile station receives control information from the second access point, which has detected it is necessary to request time sync information from the first access point, interrupts connection with the second access point in accordance with the control information, transmits a time sync information request message to the second access point, after the second access point has acquired the time sync by receiving the time sync information from the first access point, receives the time sync information from the second access point, and acquires the time sync in accordance with the received time sync information.

38. The system as claimed in claim 37, wherein the mobile station transmits time sync information of the mobile station together with the time sync information request message to the second access point.

39. The system as claimed in claim 38, wherein the time sync information of the mobile station includes information about a clock in the mobile station.

40. The system as claimed in claim 38, wherein the time sync information received from the second access point includes an offset between the time sync information of the second access point and the time sync information of the mobile station.

41. The system as claimed in claim 40, wherein the mobile station acquires the time sync by adjusting the time sync information of the mobile station in accordance with the offset.

42. The system as claimed in claim 37, wherein the mobile station requests the time sync information from the second access point at a predetermined period.
